(19) United States
(12) Patent Application Publication
(10) Pub. No.: US 2017/0308694 A1
(43) Pub. Date: Oct. 26, 2017

(54) Real-time biometric authentication through remote server

(71) Applicant: Securax Tech Solutions (I) Pvt. Ltd, Bangalore (IN)

(72) Inventor: Deepak Nagaraja BELAVADI, Bangalore (IN)

(21) Appl. No.: 15/489,929

(22) Filed: Apr. 18, 2017

(30) Foreign Application Priority Data
Apr. 22, 2016 (IN) 201641014130

(51) Int. Cl. G06F 21/45; G06F 12/0891; G06F 21/32

(52) U.S. Cl. CPC G06F 21/45; G06F 21/32; G06F 12/0891; G06F 2212/60

(57) ABSTRACT

The present invention provides a system and method for real-time biometric authentication, wherein the system comprises a local device, a remote server, a database and an access control device. The local device receives biometric input from a user and executes local verification based on one or more biometric templates temporarily stored in a cache memory of the local device. The server receives the biometric input from the local device and executes remote verification based on one or more biometric templates stored in the database, if the local verification fails. The access control device controls access to a resource based on a command received from the local device. The local device initiates deletion process for each template in the cache memory based on the time elapsed since recent access requested by the corresponding user.

### TECHNICAL FIELD OF THE INVENTION

The present invention relates to a method and system for real-time biometric authentication through a remote server. More particularly, the present invention relates to a system and method for real-time biometric authentication through a remote server capable of reducing processing load and memory requirement without increasing the power and time consumption for authenticating frequent users.

### BACKGROUND OF THE INVENTION

Authentication by measuring physical attributes such as fingerprint, facial characteristics etc., of a user to access a resource is called biometric authentication. Such resource can be a device like a computer or printer etc., a vehicle like a car or truck etc., or a location like a server room or office cubicle etc. A typical biometric authentication device includes a biometric sensor/reader, memory and a controller. During registration, the sensor/reader acquires a physical attribute of each user who has rights to access a restricted resource. The acquired information is stored in the memory and is used by the controller during subsequent authentication process.

Basically, biometric authentication can be classified into one-to-one authentication and one-to-N authentication. In one-to-one authentication, biometric information of each registered user is mapped with a non-biometric identification (ID) in a database. During authentication, the non-biometric information is received from a user and the corresponding biometric information is identified as a reference. When the user inputs biometric information, it is compared with the reference and the user is authenticated or rejected. Whereas in one-to-N authentication, biometric information of all registered users is stored in a database. During authentication, biometric input is received from a user and is compared with each biometric template stored in the database. When such a one-to-N authentication device is implemented to protect a resource that is accessible for a huge population like manufacturing plant or educational institute, the device needs to include a high capacity memory and a high-end microcontroller which increase the size, cost, complexity and power consumption of the device.

To mitigate this problem, remote authentication system is developed, wherein biometric information received from each user during registration is converted into a template and stored in a remote database. During subsequent authentication, the inputted biometric information is compared with each template in the database. Even though this system avoids the need for high end memory and processing device, the authentication process is so cumbersome that it takes a huge time in authenticating each user.

European Patent application 1,881,461 discloses a different solution, wherein the system includes a remote server connected to multiple personal authentication devices. Each device receives biometric input from a user and sends to the server that does a remote verification and sends a matching template to the device. The matching template is temporarily stored in a cache memory in the device and is used for subsequent authentication. The cache memory deletes all the templates that are not collated for the first time in a particular time period. In this case, the memory and processor requirement is minimized, but the system does not consider the recent request raised by the user, which is actually crucial information in deciding whether to delete the data or not.

Similarly, another European Patent application 2,261,839 describes a biometric matching system, wherein a remote server performs remote authentication of each user requesting access for the first time after registration. The templates are stored in a local cache memory after the remote authentication process, but are deleted from the cache memory after a predetermined time period. Even in this system, the crucial information about recent access request from the users is not considered for deleting the templates, which leads to unwanted time and power consumption for authenticating frequent users.

Hence, there is need for a system and method for real-time biometric authentication through a remote server, which can reduce processing load and memory requirement on the local device without increasing power and time consumption for authenticating frequent users. Furthermore, there is need for a system that can reduce bandwidth requirement for communication between the server and local device, and that is capable of determining the rarely used templates and deleting them when the cache memory is full.

### SUMMARY

The present invention eliminates all the drawbacks of prior arts by providing a system and method for real-time biometric authentication through a remote server, wherein the system comprises a local device, a remote server, a database and an access control device. The local device receives biometric input from a user and executes local verification based on one or more biometric templates temporarily stored in a cache memory of the local device. The server receives the biometric input from the local device and executes remote verification based on one or more biometric templates stored in the database, if the local verification fails. The access control device controls access to a resource based on a command received from the local device. The local device initiates a deletion process for each template in the cache memory based on a time elapsed since recent access requested by the corresponding user.

In one embodiment, the local device automatically initiates the deletion process at regular intervals, wherein a user is determined as a rare user, if the time elapsed since recent access requested by the user exceeds a threshold limit. The templates of such rare users are automatically deleted from the cache memory, thus providing extra space for the templates of frequent users or new users. Hence, processing load and memory requirement on the local device is minimized without increasing power and time consumption for authenticating frequent users.

In another embodiment, the local device initiates the deletion process if the cache memory reaches a maximum storage capacity of the cache memory and if a new template needs to be stored in the cache memory. A biometric template of a user who has not accessed the resource for the longest time period is deleted from the cache memory to accommodate the new template, even if the time period does not exceed the threshold limit. By this way, a user can be determined as a relatively rare user and the template thereof can be removed to accommodate a new user.

The remote server asynchronously transmits the verification result and the matching template to the local device, wherein the verification result is sent immediately to local device and the matching template is compressed and sent to the local device separately. Since the verification result is sent immediately, the local device grants access to the user in real-time without waiting for the matching template to reach the local device. This can further reduce the time required to authenticate a new/rare user. Moreover, because of asynchronous transmission, a bandwidth requirement can also be reduced to a significant level.

It is to be understood that both the foregoing general description and the following detailed description are exemplary and explanatory and are intended to provide further explanation of the invention as claimed.

### BRIEF DESCRIPTION OF THE DRAWINGS

The foregoing and other features of embodiments will become more apparent from the following detailed description of embodiments when read in conjunction with the accompanying drawings. In the drawings, like reference numerals refer to like elements.

FIG. 1 shows the block diagram of the system for real-time biometric authentication through a remote server in accordance with the first embodiment of the present invention.

FIG. 2 shows the flow diagram of the method for real-time biometric authentication through a remote server in accordance with the first embodiment of the present invention.

FIG. 3 shows the flowchart of the local verification process in accordance with the first embodiment of the present invention.

FIG. 4 shows the flowchart of the remote verification process in accordance with the first embodiment of the present invention.

FIG. 5 shows the flowchart of the deletion process in accordance with the first embodiment of the present invention.

FIG. 6 shows the flowchart of the deletion process in accordance with the second embodiment of the present invention.

FIG. 7 shows the flowchart of the remote registration of a new user in accordance with the first embodiment of the present invention.

FIG. 8 shows the block diagram of the system for or real-time biometric authentication through a remote server in accordance with the second embodiment of the present invention.

### DETAILED DESCRIPTION OF THE INVENTION

Reference will now be made in detail to the description of the present subject matter, one or more examples of which are shown in figures. Each example is provided to explain the subject matter and not a limitation. Various changes and modifications obvious to one skilled in the art to which the invention pertains are deemed to be within the spirit, scope and contemplation of the invention.

The present invention eliminates all the drawbacks of the prior arts by providing a system and method for real-time biometric authentication through a remote server, wherein the system comprises a local device, a remote server, a database and an access control device. The local device receives biometric input from a user and executes local verification based on one or more biometric templates temporarily stored in a cache memory of the local device. The server receives the biometric input from the local device and executes remote verification based on one or more biometric templates stored in the database, if the local verification fails. The access control device controls access to a resource based on a command received from the local device. The local device initiates a deletion process for each template in the cache memory based on the time elapsed since recent access requested by the corresponding user.

The local device automatically initiates the deletion process at regular intervals, wherein a user is determined as a rare user, if the time elapsed since recent access requested by the user exceeds a threshold limit. The templates of such rare users are automatically deleted from the cache memory, thus providing extra space for the templates of frequent users or new users. Hence, processing load and memory requirement on the local device are minimized without increasing the power and time consumption for authenticating frequent users.

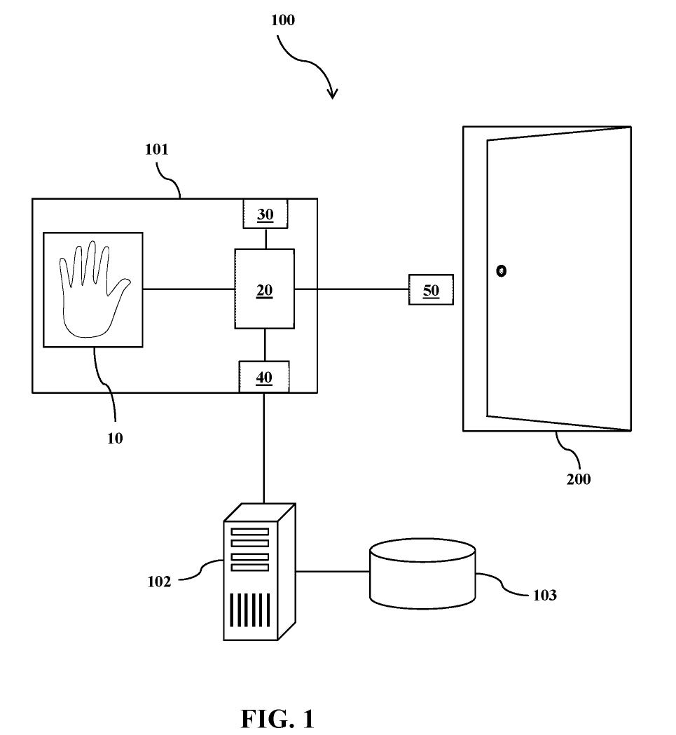

FIG. 1 shows the block diagram of the system for or real-time biometric authentication in accordance with the first embodiment of the present invention. The system (100) comprises a local device (101) installed near a resource (200) e.g. safe room, to be protected, a remote server (102) and a database (103). The local device (101) is connected to the server (102) and an access controller (50) through a wired/wireless connection. The local device (101) includes a biometrics reader (101) e.g. palm scanner, a microcontroller (20), a cache memory (30) and a transceiver (40). The biometrics reader (101) receives a biometric input from users and sends the input to the microcontroller (20). The microcontroller (20) executes a local verification of the biometric input based on one or more biometric template stored in the cache memory (30) and sends a command to the access controller (50) based on the verification. Each template in the cache memory is assigned with a timer in the microcontroller (20) with a threshold limit.

The server (102) connected to the database (103) executes remote verification by comparing the biometric input with one or more biometric templates stored in the database. If the matching template is found in the database (102), the server (102) generates and sends a verification result to the local device (101). The access controller (50) provides access e.g. opens a door of the safe room, to the user to use or operate the resource (200). The resource can also include but not limited to vehicle, desktop computer, laptop computer, palmtop computer, personal digital assistant (PDA), cellular phone, office cabin space, manufacturing facility, shopping facility, financial institution and the like.

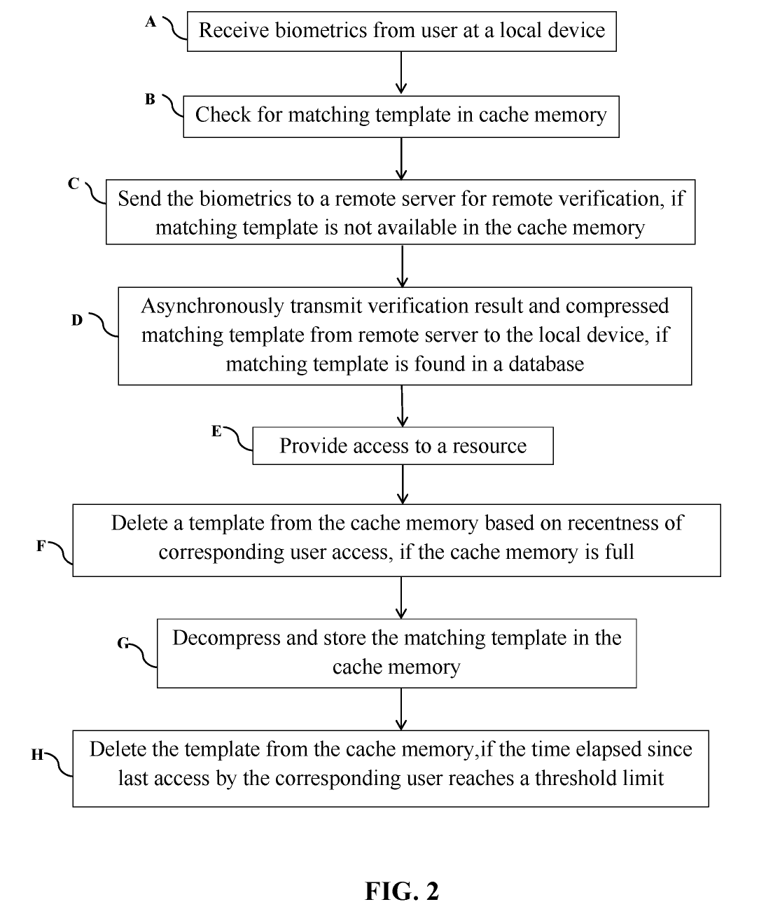

FIG. 2 shows the flow diagram of the method for or real-time biometric authentication through a remote server in accordance with the first embodiment of the present invention. The method initiates at step A by receiving a biometric input from a user at the local device (101). At step B, the cache memory (30) in the local device (101) is checked for a biometric template that matches with the biometric input. At step C, the biometric input is sent to the remote server (102) for remote verification, if the matching template is not found in the cache memory (30). At step D, if the matching template is found in the database (103), the matching template is compressed and asynchronously transmitted with a verification result. At step E, access to the resource (200) is provided, and a biometric template is deleted from the cache memory (30) based on recentness of the corresponding user access at step F, if the cache memory (30) is full. The matching template is decompressed and stored in the cache memory (30) at step G, and is deleted from the cache memory (30) if the time elapsed since the last access by the corresponding user reaches a threshold limit at step H. In the following description, the processes of local verification, remote verification, template deletion, template storage and remote registration are explained in a detailed manner.

### Local Verification

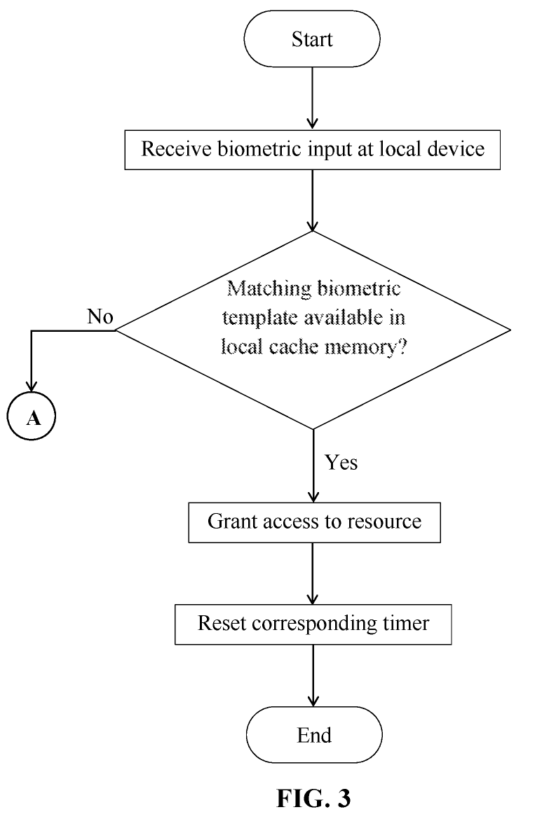

FIG. 3 shows the flowchart of the local verification process in accordance with the first embodiment of the present invention. The biometric input is received at the local device (101) through the biometrics reader (10). The microcontroller (20) compares the biometric input with the templates stored in the cache memory (30) to check if a matching template available in the cache memory (30). If the matching template is found, the microcontroller (20) generates a command to be sent to the access controller (50) and resets the timer assigned to the matching template. After receiving the command, the access controller (50) provides access i.e. opens a door of the safe room, to the resource (200). This allows frequent users to be authenticated in a quick manner without requiring a high capacity storage device to store the biometric templates.

### Remote Verification

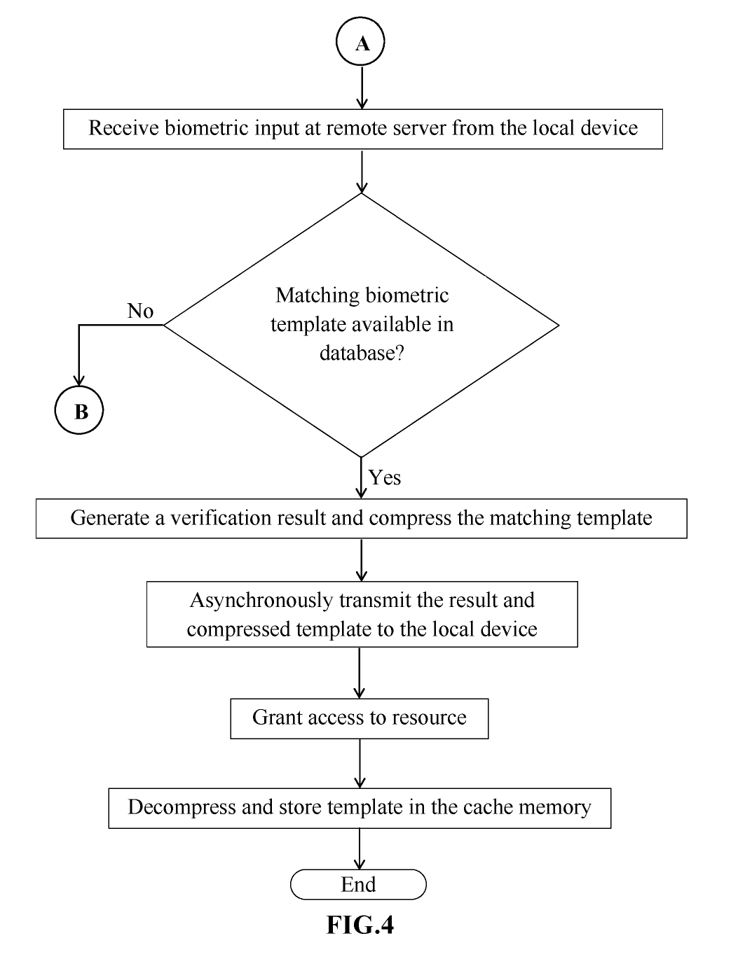

FIG. 4 shows the flowchart of the remote verification process in accordance with the first embodiment of the present invention. If the matching template is not found in the cache memory (30), the biometric input is sent to the server (102) which checks the database (103) to find the matching template. If the matching template is found in the database (103), the server (102) generates a verification result and compresses the matching template. The verification result and the compressed template are asynchronously transmitted to the local device (101). The command to grant access to the resource is generated and sent to the access controller (50). The compressed template is decompressed at the local device (101) and stored in the cache memory (30), and a timer is assigned to the template. Since the verification result is sent immediately, the local device (101) grants access to the user in real-time without waiting for the matching template to reach the local device (101). This can further reduce the time required to authenticate a new/rare user. Moreover, because of asynchronous transmission and compression, a bandwidth requirement can also be reduced to a significant level.

### Deletion Process

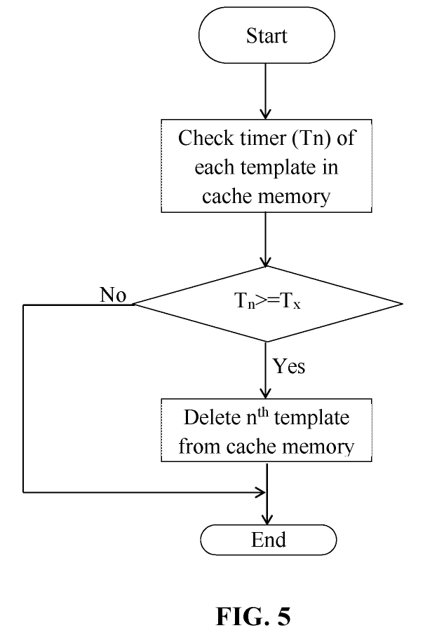

FIG. 5 shows the flowchart of the deletion process in accordance with the first embodiment of the present invention. Each of the biometric templates (1^{st}, 2^{nd}, 3^{rd} . . . n^{th}) is assigned with a timer (T₁, T₂, T₃ . . . Tₙ) in the microcontroller (20), while storing the biometric templates in the cache memory (30) for the first time. The timers are reset after successful local verification of the corresponding biometric templates. Each biometric template is deleted from the cache memory (30) under the following condition:

Tₙ>=Tₓ,

wherein Tₙ is the timer of n^{th} biometric template and Tₓ is the threshold limit. Thus deleting the biometric template, only when the time elapsed since the last access by the corresponding user reaches the threshold limit. Since the biometric templates of such rare users are automatically deleted from the cache memory (30), extra space will be provided for the biometric templates of frequent users or new users. Hence, processing load and memory requirement on the local device (101) is minimized without increasing power and time consumption for authenticating frequent users.

### Template Storage Process

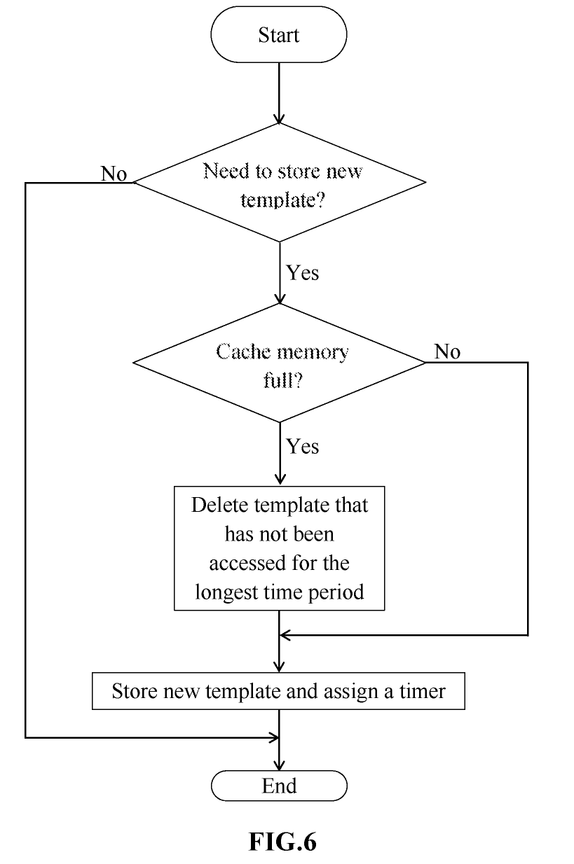

FIG. 6 shows the flowchart of the deletion process in accordance with the second embodiment of the present invention. Whenever the remote verification succeeds or a new user registers, there will be need for storing a new biometric template into the cache memory (30). In such case, the microcontroller (20) checks if the cache memory has reached maximum capacity thereof. If the maximum capacity is not reached, the new template is stored in the cache memory (30) and a timer is assigned to the new template in the microcontroller (20). If the maximum capacity is reached, the microcontroller (20) checks the timers to find out the template that has not been accessed for the longest time period. The microcontroller (20) deletes the template to make space for the new template to be stored. The new template is stored in the cache memory and the timer of the deleted template is reset and reassigned to the new template. By this way, a user can be determined as a relatively rare user, even if the timer does not reach the threshold limit, and thus the template thereof can be removed to accommodate a new user.

### Remote User Registration

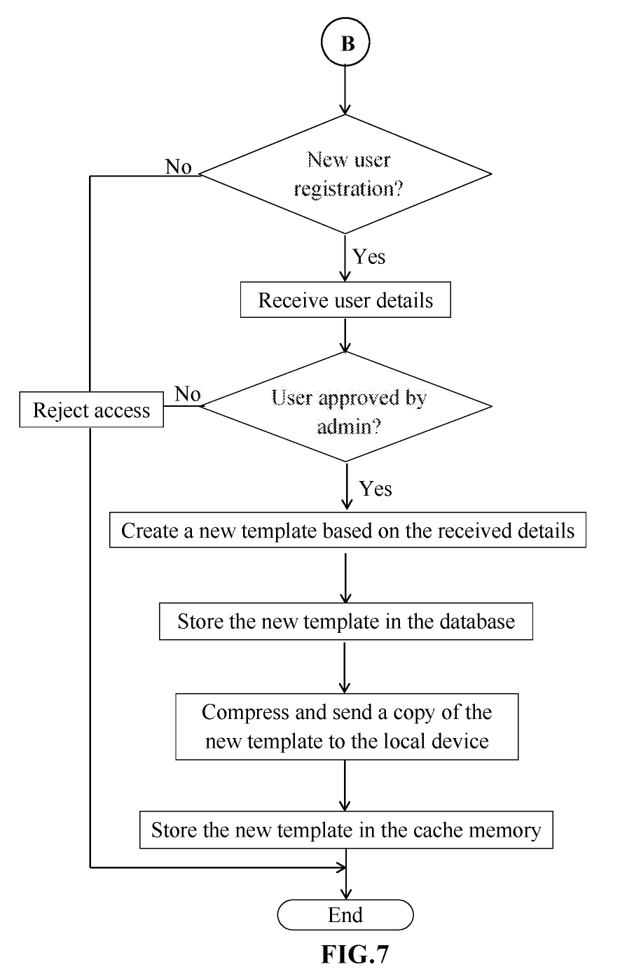

FIG. 7 shows the flowchart of the remote registration of a new user in accordance with the first embodiment of the present invention. Whenever the remote verification fails, the remote server (102) checks if a new user registration has to be performed. If negative, the access to the resource (200) is rejected at the local device (101). If a new user registration has to be performed, then the remote server (102) sends a request to receive a set of details from the local device (101), which are entered by the user at the local device (101). If a system administrator approves the user, anew biometric template is created at the server (102) and stored in the database (103). A verification result is generated, and a copy of the new template is compressed and asynchronously transmitted with the verification result to the local device (101) for storing in the cache memory (30). The approval from the administrator is received at the local device (101) by obtaining the biometric input from the administrator. This helps in avoiding need for the administrator and user to be present at the server (102) for registering the user. In another embodiment, the approval may be received at the server (102),If the approval is not received from the administrator; the access to the resource (200) is rejected at the local device (101).

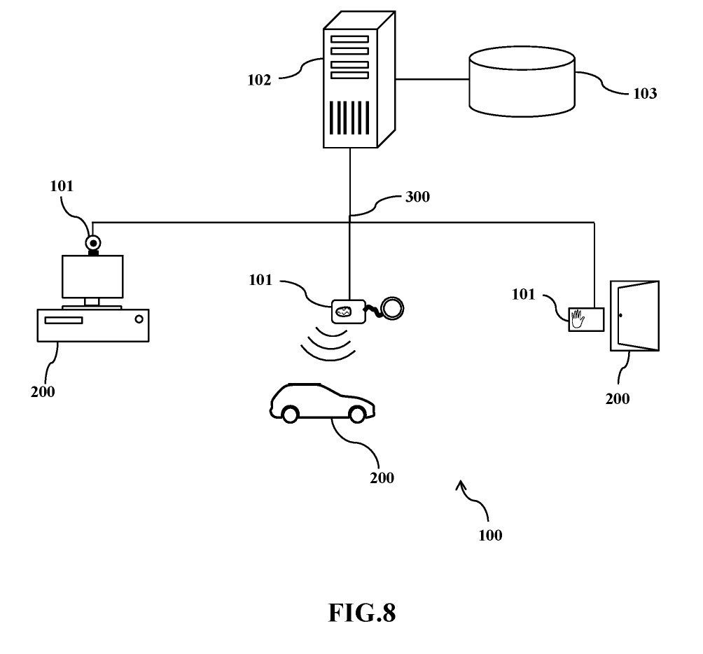

FIG. 8 shows the block diagram of the system for real-time biometric authentication through the remote server in accordance with the second embodiment of the present invention. The system (100) comprises multiple local devices (101), a remote server (102) and a database (103), wherein the local devices are connected to the remote server (102) through a network (300). The network (300) may be a wired network, cellular network, Wi-Fi network or any other network that allows the local devices (101) to communicate with the server (102) in real-time. Similarly, each local device (101) is provided in proximity to a corresponding resource (200) to be protected. Moreover, each local device (101) is capable of receiving a biometric input from a user, wherein the biometric input may be palm print, finger print or iris. In other embodiments, the biometric input can also include but not limited to palm vein, face, DNA, hand geometry, retina, odor/scent, gait, voice or any other measurable human characteristics. Furthermore, the local device (101) may be a unit separate from the resource (200) such as a door entry control unit, or installed within a part of the resource (200) such as a key fob of a vehicle, or even integrated with the resource (200) itself such as an access control driver installed in a desktop computer. The server (102) may identify each local device (101) by a unique ID assigned to the local device (101). This may avoid confusion during authentication and registration processes.

Since a single server (102) and database (103) are shared between multiple local devices (101), consumption of resource, power and expense is reduced to a significant level. In addition, the users are identified as rare users based on the recentness of their access to the resources (200), and so the corresponding templates are deleted only from the cache memory (30) to reduce processing load and memory requirement on the local device (101) without increasing power and time consumption for authenticating frequent users. Likewise, the asynchronous communication between the server (102) and the local devices (101) reduces the bandwidth requirement for communication between the server (102) and local devices (101).

It is to be understood, however, that even though numerous characteristics and advantages of the present invention have been set forth in the foregoing description, together with details of the structure and function of the invention, the disclosure is illustrative only. Changes may be made in the details, especially in matters of shape, size, and arrangement of parts within the principles of the invention to the full extent indicated by the broad general meaning of the terms in which the appended claims are expressed.

We claim:

1. A system for real-time biometric authentication, the system comprising:
at least one local device for receiving biometric input from a user and executing local verification based on one or more biometric templates temporarily stored in a cache memory of said local device;
a remote server for receiving said biometric input from said local device and executing remote verification based on one or more biometric templates stored in a database, if the local verification fails;
an access control device connected to a resource for controlling access to said resource based on a command received from said local device,
wherein said local device initiates a deletion process for each biometric template in said cache memory based on a time elapsed since recent access requested by the corresponding user.

2. The system as claimed in claim 1, wherein said local device automatically initiates the deletion process.

3. The system as claimed in claim 2, wherein said local device deletes a biometric template of a user from said cache memory, if the time elapsed since recent access requested by the user exceeds a threshold limit.

4. The system as claimed in claim 1, wherein said local device initiates the deletion process if said cache memory reaches a maximum storage capacity of said cache memory and if a new template needs to be stored in said cache memory.

5. The system as claimed in claim 4, wherein said local device deletes a biometric template of a user who has not accessed the resource for the longest time period.

6. The system as claimed in claim 1, wherein said local device executes the local verification by comparing said received biometric input with at least one biometric template stored in said cache memory.

7. The system as claimed in claim 6, wherein said local device sends a command to the access control device for granting access to the resource, if a matching template is found in said cache memory.

8. The system as claimed in claim 1, wherein said remote server executes the remote verification by comparing said received biometric input with at least one biometric template stored in said database, if the local verification fails.

9. The system as claimed in claim 8, wherein said remote server asynchronously transmits a verification result and the matching template to said local device, if the matching template is found in said database.

10. The system as claimed in claim 9, wherein said remote server compresses the matching template before the transmission.

11. The system as claimed in claim 9, wherein said local device sends a command to the access control device based on the verification result.

12. The system as claimed in claim 9, wherein said local device decompresses the received template and temporarily stores the decompressed template in said cache memory.

13. A method for real-time biometric authentication, the method comprising:
receiving biometric input from a user at a local device;
executing local verification based on one or more biometric templates temporarily stored in a cache memory of said local device;
receiving said biometric input at a remote server from said local device, if the local verification fails;
executing remote verification at the remote server based on one or more biometric templates stored in a database;
asynchronously transmitting a verification result and a matching template to said local device, if the remote verification succeeds;
controlling access to a resource based on the verification result;
temporarily storing the matching template in the cache memory, where in a deletion process is executed for each biometric template in said cache memory based on a time elapsed since recent access requested by the corresponding user.

14. The method as claimed in claim 13, wherein the deletion process is automatically initiated at regular intervals.

15. The method as claimed in claim 14, wherein the deletion process includes automatically deleting a biometric template of a user from said cache memory, if the time elapsed since recent access requested by the user exceeds a threshold limit.

16. The method as claimed in claim 13, wherein the deletion process is initiated if said cache memory reaches a maximum storage capacity of said cache memory and if a new template needs to be stored in said cache memory.

17. The method as claimed in claim 16, wherein the deletion process includes deleting a biometric template of a user who has not accessed the resource for the longest time period.

18. The method as claimed in claim 13, wherein the step of executing the local verification includes comparing the received biometric input with at least one biometric template stored in said cache memory.

19. The method as claimed in claim 18, wherein the step of executing the local verification further includes sending a command to an access control device for granting access to the resource, if a matching template is found in said cache memory.

20. The method as claimed in claim 13, wherein the step of executing the remote verification includes comparing the received biometric input with at least one biometric template stored in said database.

21. The method as claimed in claim 20, wherein the step of executing the remote verification includes asynchronously transmitting a verification result and the matching template to said local device, if the matching template is found in said database.

22. The method as claimed in claim 21, wherein the step of executing the remote verification further includes compressing the matching template before the asynchronous transmission.

23. The method as claimed in claim 21, wherein the step of controlling the access to the resource includes sending a command to the access control device (50) based on the verification result.

24. The method as claimed in claim 22, wherein the step of temporarily storing the template includes decompressing the received template and storing the decompressed template in said cache memory.
